(19) United States
(12) Patent Application Publication
(10) Pub. No.: US 2014/0188519 A1
(43) Pub. Date: Jul. 3, 2014

(54) SYSTEMS AND METHODS FOR COORDINATING THE DELIVERY OF HIGH-QUALITY HEALTH CARE OVER AN INFORMATION NETWORK

(71) Applicant: EPREOP, LLC, Seal Beach, CA (US)

(72) Inventors: David Bergman, Rossmoor, CA (US); Manoj Kulkarni, Dana Point, CA (US); Reid Wilburn, Tarpon Springs, FL (US); Lynnus Peng, Anaheim, CA (US); Michael Downing, Thousand Oaks, CA (US)

(73) Assignee: EPREOP, LLC, Seal Beach, CA (US)

(21) Appl. No.: 14/150,481

(22) Filed: Jan. 8, 2014

Related U.S. Application Data
(63) Continuation of application No. 13/468,732, filed on May 10, 2012, now abandoned.
(60) Provisional application No. 61/484,608, filed on May 10, 2011.

(51) Int. Cl. G06F 19/00

(52) U.S. Cl. CPC G06F 19/322
USPC 705/3

(57) ABSTRACT

The field of the invention relates to systems and methods for managing healthcare information systems, and more particularly to systems and methods for coordinating the delivery of high-quality health care and medical services over an information network. In one embodiment, a processing server is configured to electronically receive a patient's health information over a data network from one or more patient systems. The processing server also includes a computer program product having a computer-usable medium including a sequence of instructions which, when executed by a processor, causes said processor to execute a process that coordinates the delivery of transferrable patient health information and provides preoperative testing recommendations based on a single acquisition of electronic patient health information. The process includes the steps of retrieving patient health information; distributing patient health information over said data network; submitting automated authorization requests; providing patient-specific clinical decision support in the form of evidence-based testing guidelines and preoperative recommendations, wherein the recommendations are based on medical triggers and factors acquired from said patient health information; and generating a quality reporting record.

### CROSS REFERENCES TO RELATED APPLICATIONS

This application is a continuation of U.S. patent application Ser. No. 13/468,732, filed May 10, 2012, which claims the benefit of U.S. Provisional Patent Application No. 61/484,608, filed May 10, 2011, which applications are hereby incorporated by reference in their entirety.

### FIELD OF THE INVENTION

The field of the invention relates to systems and methods for managing healthcare information systems, and more particularly to systems and methods for coordinating the delivery of high-quality health care and medical services over an information network.

### BACKGROUND OF THE INVENTION

Health care practitioners and clinicians are generally asked to assess the preoperative risk in patients who are to undergo medical procedures. In determining this risk, a patient's medical history/condition is screened prior to a medical procedure to discover any problematic areas or concerns, for which further tests may be required. Failing to properly screen or perform a pre-procedural test may lead to adverse complications from or reactions during an operation due to previously unknown/unrecognized health risks. Health insurance authorization further complicates the pre-procedural process involving a number of insurers, each with unique authorization requirements. As a result, multiple patient interviews, excessive testing, and scheduling delays is common during the pre-procedural screening.

In fact, it has been estimated that approximately one-third of the $2 trillion of annual health care costs in the United States is spent on unnecessary hospitalizations and tests, unproven treatments, and generally, wasted care. See, e.g., Reducing Health Care Costs, Improving Care, U.S. News & World Report, Sep. 20, 2010. See also, Doctor Panels Recommend Fewer Tests for Patients, N.Y. Times, Apr. 4, 2012, pp. A10.

The problem of unwarranted testing and unnecessary procedures results, in part, from fear of liability, fear of case delays/cancellations, and lack of sufficient knowledge regarding recommended guidelines. Medical practitioners and health care providers continuously face medical regulations, legal pressures, and rising competition with minimal room for error. Therefore, patients typically submit to multiple preoperative interviews and excessive testing to avoid delays and minimize, or at least quantify, the risk to the patient.

Conventional methods for preoperative screening generally involve administering medically recognized questionnaires to gather a patient's information. The questionnaire provides insight into the patient's current and past health condition; however, the physician and medical staff are still required to complete the analysis and determine whether any additional pre-procedural testing/preparation is required for the given medical data. Therefore, human error and lack of sufficient knowledge regarding particular guidelines may affect a successful diagnosis/treatment of a patient. In some cases, without immediate knowledge of recommended guidelines, physicians may order unnecessary tests to err on the side of caution or, alternatively, overlook a necessary condition/guideline requiring further testing. Unsuccessful patient analysis and preparation is a common source for operative delays/cancellations, postoperative complications, and increased costs.

One approach for assisting physicians and other health professionals with analyzing patient data provides computer-based recommendations for preoperative patient evaluations and testing. An example is provided in U.S. patent application Ser. No. 10/861,877, filed Jun. 3, 2004, by David E. Young, for a “System and Method of Evaluating Preoperative Medical Care and Determining Recommended Tests Based on Patient Health History and Medical Condition and Nature of Surgical Procedure” (“Young”), which is hereby incorporated by reference in its entirety. A method is disclosed whereby recommendations for preoperative patient evaluations and testing are determined based on electronic patient data. Specifically, the patient data is compared against evaluation tables relating surgical procedures and preoperative testing, medical conditions and preoperative testing, and surgical procedures and patient medical condition to determine recommendations.

Although this approach may be useful for providing greater preoperative assurances, evaluation tables may limit the number of discrete patient variables considered. A number of medically recognized procedures and guidelines require an analysis of multiple variables (e.g., screening for obstructive sleep apnea syndrome typically involves an analysis of 8 questions, also known as “STOP-BANG”). Limiting the number of patient variables correspondingly limits the consideration of those medically recognized guidelines requiring multivariate analysis and complex algorithms (e.g., STOP-BANG score is based on positive responses to 3 of 8 variables).

As an additional setback, the pre-procedural process involves not only a number of medical personnel (e.g., surgeons, anesthesiologists, nurses, specialists, technicians, and other ancillary staff), but also a number of medical sites (e.g., physician offices and/or procedural facilities). Multiple staff members, at each location, often administer the medically recognized questionnaires, discussed above. In light of the number of both personnel and facilities involved in the preoperative process, traditional (e.g., paper-based) methods for obtaining/accessing a patient's medical information and medical records prior to evaluating any recommendations can be redundant and burdensome.

Electronic medical records (“EMR”) and electronic health records (“EHR”) have been developed to facilitate the maintenance of health care information, also known as health information management (“HIM”). Each record promotes the systematic collection of electronic health information and may contain a range of data, including, for example, medical history, medication, allergies, laboratory test results, personal stats, and so on. Several databases are typically used to store patients' medical record in a digital format to allow for the distribution and transferability of health information across different medical settings. For example, network-based systems may be used to achieve the benefits of health information exchanges (“HIE”) via synchronized data between client and server systems. In fact, the system and method described in Young assumes the use of electronic health records and patient information. Unfortunately, few standards/regulations exist for maintaining electronic records and each facility may have its own guidelines, coding systems, and rules regarding HIM. As a result, although patient health information and real-time guidelines may be locally exchanged and standardized, the compatibility among various health care providers is effectively limited.

Even in fully integrated hospitals and HIM systems, medical records are not always accessible to all personnel involved with a particular patient, particularly if the patient is removed from their normal health care provider. Without immediate access to an EHR or EMR, the pre-procedural process necessitates a comprehensive battery of pre-operative interviews and tests, many unwarranted and costly. This redundant process is a burden on both the patient and the medical system. The results of each test further require data entry into multiple HIMs. Manually updating and maintaining the databases of patient information can be labor intensive and often redundant.

In addition to gathering the necessary medical information from a patient, the preoperative process additionally consists of prior insurance authorization requests and various quality-reporting methods. Health insurance plans generally reimburse approved health care providers for care required beyond that of the primary physician. The process whereby an insurance plan recognizes this care for reimbursement is known as “authorization.” Submission of insurance authorization requests can be manual or semi-automated; however, this process is highly variable given the number of different health insurance providers, each with unique requirements. Although these unique requirements are often based on patient information previously obtained, current systems and methods for maintaining electronic health information are typically disjointed from the remaining pre-procedural process (e.g., authorization requests, scheduling, and so on). Therefore, completing a successful authorization process demands manual entry of redundant patient information—such as previously obtained in the preoperative interviews discussed above. Authorization delays and denials impart similar unnecessary costs in both resources and finances.

Accordingly, an improved system and method for facilitating the pre-procedural process, such as by managing electronic patient health information, submitting coordinated insurance authorizations, presenting clinical decision support, and reporting quality measures based on an algorithmic analysis of said electronic patient health information and using the systems and methods descried herein is desirable.

### SUMMARY OF THE INVENTION

The field of the invention relates to systems and methods for managing healthcare information systems, and more particularly to systems and methods for coordinating the delivery of high-quality health care and medical services over an information network. In one embodiment, a processing server is specially configured to electronically receive a patient's health information over a data network from one or more patient systems. The processing server also includes a computer program product having a computer-usable medium including a sequence of instructions which, when executed by a processor, causes said processor to execute a process that coordinates the delivery of transferrable patient health information between the provider server and one or more client devices and provides preoperative testing recommendations based on a single acquisition of said patient health information.

The process includes the steps of retrieving patient health information; distributing patient health information over said data network; submitting automated authorization requests; providing patient-specific clinical decision support in the form of evidence-based testing guidelines and preoperative recommendations, wherein the recommendations are based on medical triggers and factors acquired from said patient health information; and generating a quality reporting record.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

In order to better appreciate how the above-recited and other advantages and objects of the inventions are obtained, a more particular description of the embodiments briefly described above will be rendered by reference to specific embodiments thereof, which are illustrated in the accompanying drawings. It should be noted that the components in the figures are not necessarily to scale, emphasis instead being placed upon illustrating the principles of the invention. Moreover, in the figures, like reference numerals designate corresponding parts throughout the different views. However, like parts do not always have like reference numerals. Moreover, all illustrations are intended to convey concepts, where relative sizes, shapes and other detailed attributes may be illustrated schematically rather than literally or precisely.

FIG. 1 is a diagram of a data network providing communication between a provider-processing server and one or more patient client devices.

FIG. 2 is a flowchart of a process in accordance with a preferred embodiment of the present invention.

FIG. 3 is another flowchart further detailing a process described in FIG. 2 in accordance with a preferred embodiment of the present invention.

FIG. 4 is another flowchart further detailing a process described in FIG. 2 in accordance with a preferred embodiment of the present invention.

FIG. 5 is a sample screenshot showing an exemplary recommendation report generated in accordance with the present invention

FIG. 6a is a sample screenshot showing an exemplary checklist based on a generated recommendation report for use with the present invention;

FIG. 6b is another sample screenshot showing an exemplary checklist based on a generated recommendation report for use with the present invention;

FIG. 6c is another sample screenshot showing an exemplary checklist based on a generated recommendation report for use with the present invention; and

FIG. 7 is another sample screenshot illustrating an insurance pre-authorization request using a patient's existing EHR.

### DETAILED DESCRIPTION OF THE PREFERRED EMBODIMENTS

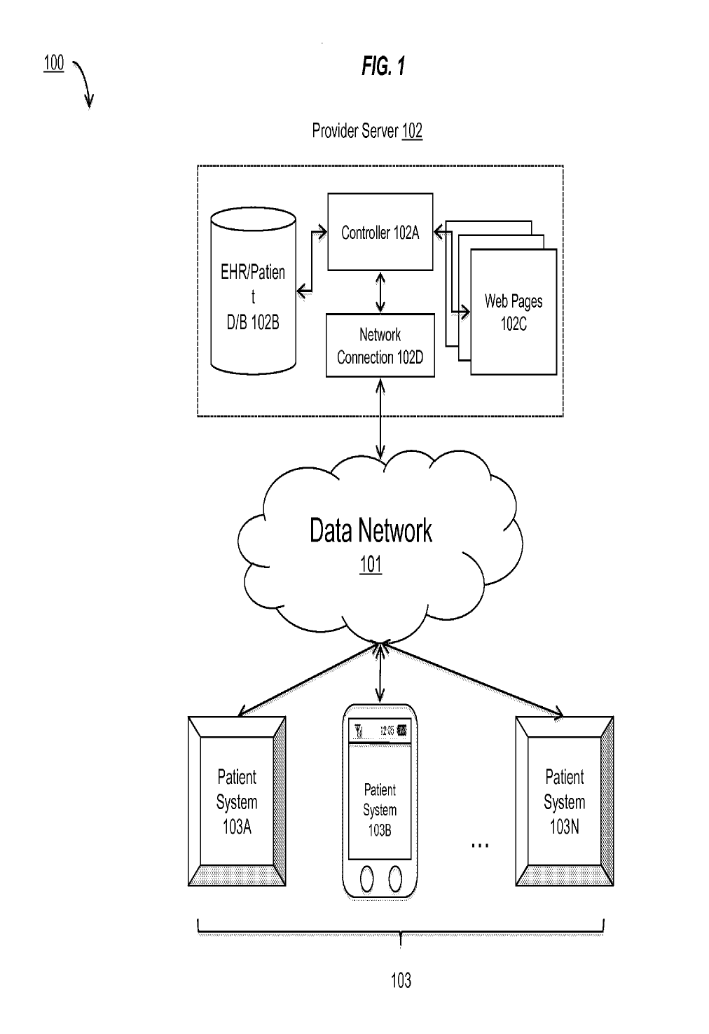

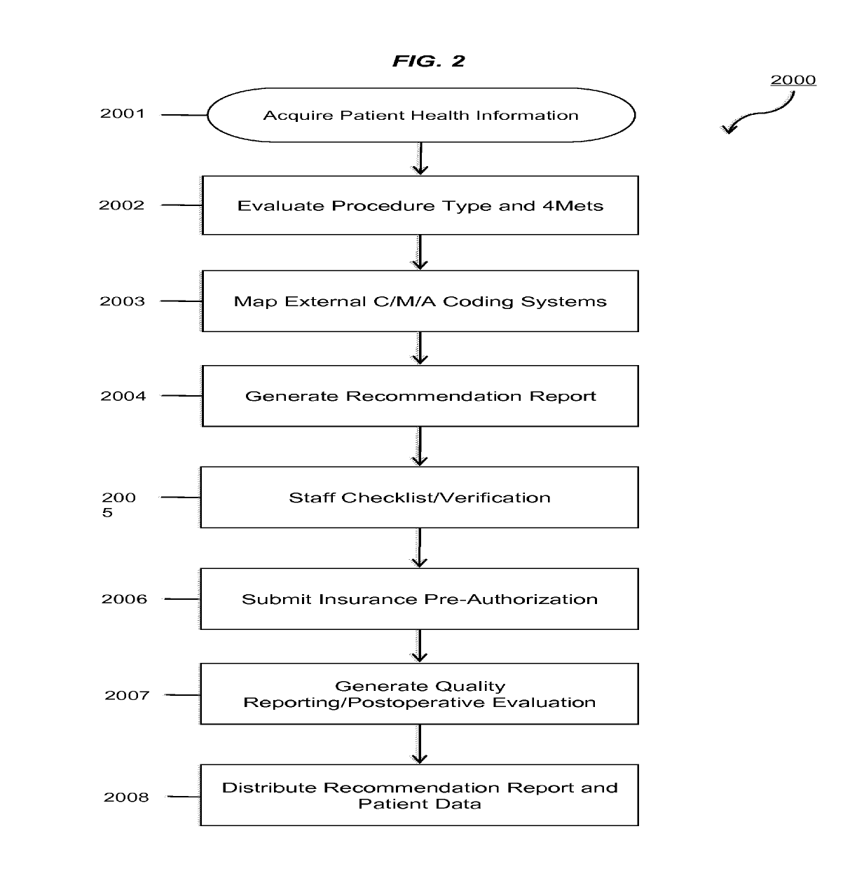

As described above, health information management (“HIM”) typically involves a combination of paper-based and electronic medical records (“EMR”)/electronic health records (“EHR”). Electronic records support the mobilization of healthcare information across various health care information systems. Turning to FIG. 1, an exemplary network-based computer system 100 that allows for health information exchange (“HIE”) is illustrated in block-diagram form. The system 100 has a provider server 102, indicated by the dashed lines in FIG. 1 that includes a controller 102A for controlling access to an EHR/patient database 102B.

Patient database 102B maintains, inter alia, electronic patient information, including, EMR, EHR, and demographic information. As one of ordinary skill in the art would appreciate, patient database 102B may be any type of mass storage device or storage medium, such as, for example, magnetic hard disks, floppy disks, cloud storage, optical disks (e.g., CD-ROMs), flash memory, DRAM, and may also include a collection of devices (e.g., Redundant Array of Independent Disks (“RAID”)). It should similarly be understood that patient database 102B and provider server 102 could reside on the same computing device or on different computing devices in communication with each other. In a preferred embodiment, database 102B is organized as a relational database (e.g., user-specific mapping to a medical concept and coding-system mapping to a medical concept); although it should be understood that other hierarchical- and network-based database models may be used.

Provider server 102 is accessible over a data network 101 through network connection 102D. Data network 101 may be any one of a global data network (e.g., the Internet), a regional data network, or a local area network. Network connection 102D supports both wired and wireless data communication and includes high-speed Ethernet devices. Network connections are implemented using any known high-level protocols, such as TCP/IP and may comprise multiple networks of differing protocols connected through appropriate gateways.

In one embodiment, provider server 102 also hosts and provides access to several Web pages 102C. Patient information—such as the data stored in Patient database 102B—can be exchanged and viewed through Web pages 102C. Each Web page 102C is identifiable via unique Uniform Resource Locators (“URL”) and accessible using common networking protocol (e.g., HyperText Transfer Protocol (“HTTP”), HTTP Secure (“HTTPS”), Transport Layer Security (“TLS”), and Secure Sockets Layer (“SSL”)) requests. Controller 102A is used to process URL requests.

System 100 also includes several patient systems 103A, 103B, and 103N for exchanging health information over data network 101. Users 103 communicate with provider server 102 from each of patient system 103A, 103B, and 103N. Users 103 include surgeons, physicians, medical practice groups, patients, medical staff, anesthesiologists, hospitals, clinics, health maintenance organizations (HMO), insurance groups, and so on. Patient systems 103A, 103B, and 103N are preferably Internet-based communication systems. Examples include, but are not limited to, laptops, desktops, mobile phones, personal digital assistants (PDA), portable multimedia players, kiosks, multiprocessor systems, microprocessor-based systems, programmable consumer electronics, telephony systems, distributed computing environments, set top boxes, and so on.

As previously mentioned, for conventional HIM systems 100 using EHRs and EMRs, patient information is often stored in multiple formats/coding classifications and not always readily accessible to the necessary medical personnel for proper diagnosis, treatment, insurance authorization, quality reporting, and so on. Accordingly, the pre-procedural process is disjointed, redundant, costly, and prone to human error. As a result, medical personnel tend to administer multiple patient interviews, excessive testing, and variable health information exchanges. Although this process may successfully prepare a patient for a medical procedure, each step can undesirably lengthen/delay the medical procedure, allow for human error, increase the risk of medical complications, and increase costs.

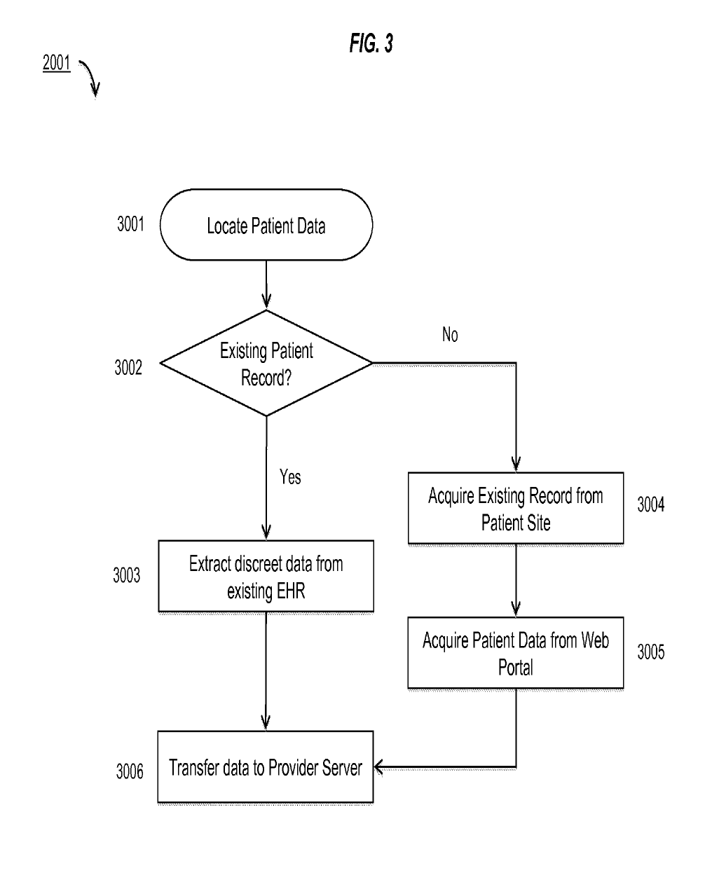

One approach to address this issue is shown in FIG. 2, which illustrates a process 2000 that may be executed within provider server 102. Process 2000 begins with the acquisition of a patient's health information (starting block 2001). FIG. 3 illustrates starting block 2001 in further detail. Provider server 102 first determines whether a patient's information is currently stored in EHR/patient database 102B (starting block 3001). For patients with existing medical records stored within provider server 102 (e.g., from a previous intake) (decision block 3002), discrete health data is extracted from database 102B (action block 3003) for further processing (action block 3006). In one embodiment, each entry in a health record is maintained as a single element within database 102B (e.g., a single entry in a Linked List, Hash Map, and so on).

Alternatively, for patients without existing records in database 102B (decision block 3002), provider server 102 may acquire patient health information from previously existing EHRs located outside of provider server 102, thereby reducing the number of patient interviews required at any location (e.g., records from alternative medical facilities) (action block 3004). In one embodiment, patient health information may exist on patient systems 103A, 103B, or 103N located at various physician offices, medical facilities, or ambulatory EHRs. These records include medical history, demographics, medication, allergies, test results, radiology imaging, personal statistics, vitals, insurance information, and so on. Those of ordinary skill would appreciate that various facilities may have unique rules for maintaining/encoding EHRs. Thus, previously existing records may be encoded using various medical classifications, in which descriptions of the patient data are mapped to universal medical code numbers. For example, the International Statistical Classification of Diseases and Related Health Problems (“ICD”) is a medical classification that groups similar clinical concepts into categories. The use of reference classifications (e.g., ICD-8, ICD-9, ICD-10) and similar medical coding systems (e.g., Systemized Nomenclature of Medicine (“SNoMed”), diagnosis classifications, current procedural terminology (“CPT”), procedural classifications) are well understood and appreciated.

For any previously existing EHRs located outside of provider server 102, provider server 102 retrieves discrete patient data in its native form (e.g., using original medical classifications) from remote sites (e.g., patient systems 103A, 103B, 103N) and stores the data in patient database 102B, as discussed above.

Following an attempt to acquire any information from remote sites, provider server 102 can similarly acquire patient health information from Web-based portals (action block 3005). In one example, patients from any location—such as patients using systems 103A, 103B, or 103N—can log into Web pages 102C hosted on provider server 102, over data network 101, to view their own medical history, condition, and other information. The patients can similarly submit information through Web pages 102C to be stored in patient database 102B. Additionally, medical personnel can create a new EHR for a patient during a patient's intake, surgical authorization request, procedural scheduling, and so on using patient systems 103A, 103B, 103N (e.g., administering medically recognized questionnaires). Therefore, medical procedure authorizations and scheduling can similarly initiate the information acquisition of process 2002. This patient health information is submitted to provider server 102 over data network 101 (e.g., via Web pages 102C) (return block 3006).

Returning to FIG. 2, once provider server 102 acquires and stores a patient's electronic health information, the medical personnel subsequently reviews the information prior to processing (action block 2002). Specifically, medical personnel have a chance to correct/update any patient data that may be outdated, missing, or incorrect. EHRs and EMRs are frequently inaccurate (e.g., extraneous data, incomplete data, and so on), particularly where electronic records are transferred from alternative sources (i.e., outside of database 102B). For example, these inaccuracies may occur where specialized surgeons only acquire specialized data or claims-based data is not purged from a record. Process 2000 allows for medical personnel to review and correct inaccurate data prior to any further propagation across a data network. Furthermore, in order to generate a recommendation report for a particular type of medical procedure based on the patient's current health information/condition, the medical personnel must also submit information related to the particular procedure to provider server 102 in action block 2002.

In a preferred embodiment, this includes providing both the operation type and functional metabolic capacity/exercise tolerance. As those of ordinary skill in the art would appreciate, medical personnel may determine a patient's exercise tolerance/functional metabolic capacity in terms of a metabolic equivalent (“MET”) value measurement (e.g., asking a “4 METs” question, such as “Can the patient climb two flights of stairs or do heavy housework without any significant chest pain or shortness of breath?”). The medical personnel must also indicate the specific procedure (e.g., heart surgery) the patient will undergo to receive recommendations for that particular operation. This procedure may be surgical or non-surgical (e.g., gastroenterological, radiological, and so on). The acquired patient record and procedure type is submitted to provider server 102, directly or over data network 101.

After the necessary information is gathered and reviewed, process 2000 translates the electronic health data into a single recognizable format (action block 2003). In a preferred embodiment, ICD-9 coding is used to map health conditions and CPT coding is used for health services. As previously discussed, existing EHRs located outside of provider server 102 may use various medical classifications/coding methods and come in a number of medically recognized formats. Provider server 102 is configured to recognize a list of external coding systems/methods to create a mapping between external codes and an internal coding format that can be stored in patient database 102B. Users of patient systems 103A, 103B, and 103N can specify the list of external coding systems for which a patient's health data is provided as well as the order in which coding system mapping will be attempted (e.g., custom-user mapping to override system-level defaults).

In one embodiment, the Unified Medical Language System (“UMLS”) is used to integrate and distribute key terminology, classification and coding standards, and associated resources. The UMLS provides a mapping resource between various coding standards and languages such that conditions, medications, allergies (“C/M/A”), procedure risk, and so on can be translated/mapped into a specific classification system.

For example, a patient's C/M/A acquired outside of patient database 102B may include a combination of medical concepts in both text and encoded using ICD-8 classifications. Provider server 102 parses and maps each C/M/A using the UMLS to a single coding system (e.g., ICD-9) for storage in patient database 102B. In another example, the particular type of medical procedure acquired in action block 2002 can be similarly mapped to a CPT code to communicate information regarding the risk of procedure (i.e., low-, intermediate-, and high-risk) (e.g., based on medically recognized guidelines for the risk of cardiac complications). This information is stored in patient database 102B using a single coding format. Accordingly, process 2000 provides the advantage of supporting the mobilization of electronic health information. Standardizing various EHR formats/classifications to a single internal coding system allows provider server 102 to receive a number of records in various formats and exchange information across information networks, such as over data network 101 to systems 103A, 103B, and 103N. Physicians and physician staff members can then use this real-time standardized information to evaluate the preoperative risk for a patient that is to undergo medical procedures. Nevertheless, manual evaluation still may introduce human error and lack of sufficient knowledge regarding particular guidelines, which may affect a successful diagnosis/treatment of a patient.

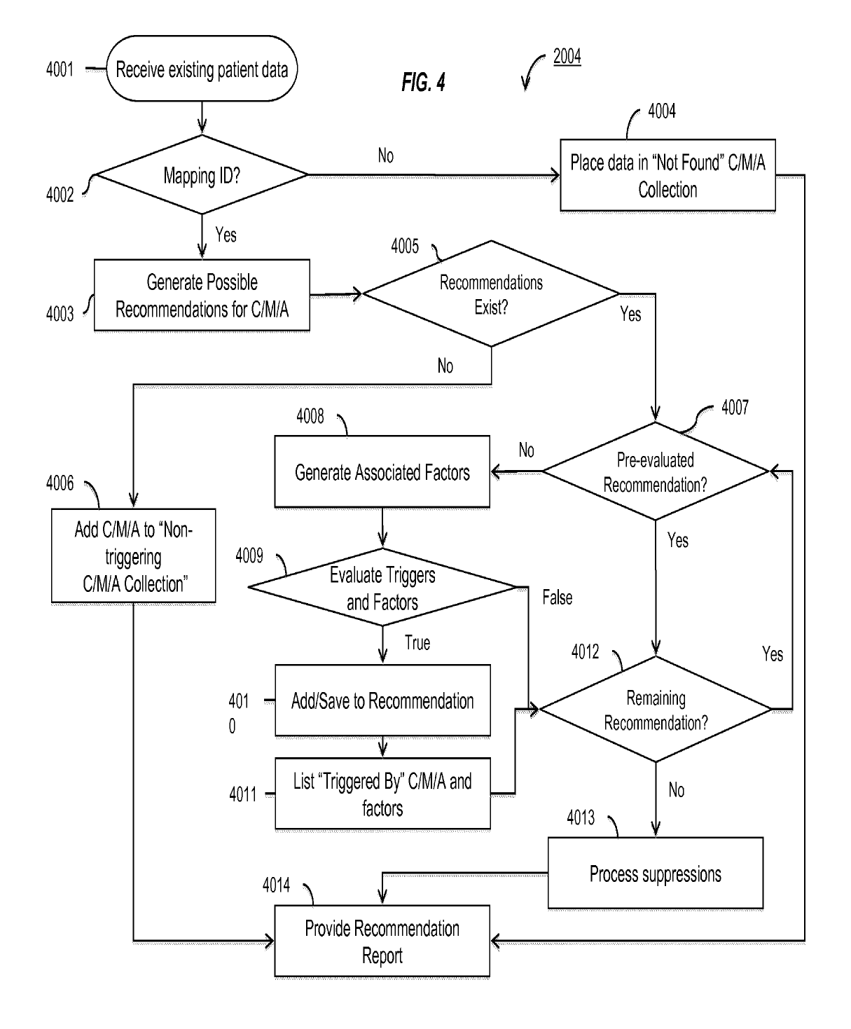

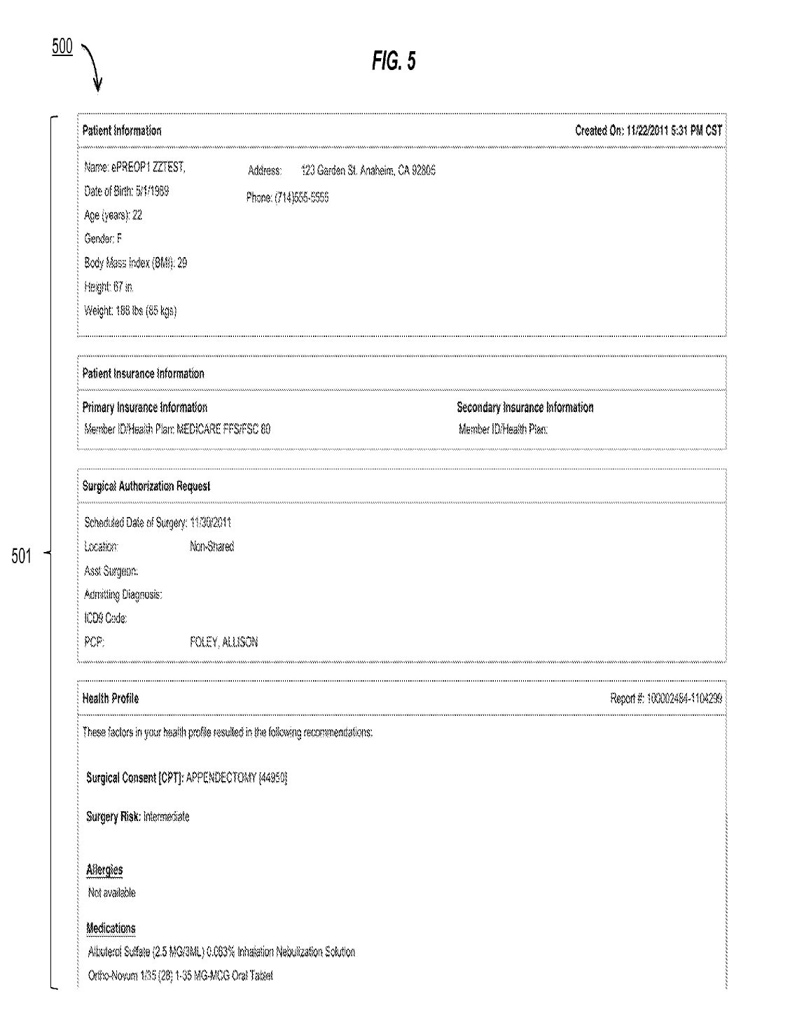

As illustrated in FIG. 2, in light of the above, provider server 102 can use the standardized information to provide clinical decision support in the form of patient-specific evidence-based testing guidelines and preoperative recommendations (action block 2004). The clinical decision support includes recommendations for pre-procedural care, testing, scheduling, and consultation considerations to influence physicians'/medical personnel health decisions and diagnosis for improved care. Each recommendation considers evidence- or consensus-based clinical practice guidelines (e.g., the American College of Cardiology/American Heart Association (“ACC/AHA”) Guidelines on Perioperative Cardiovascular Evaluation and Care for Non-cardiac Surgery for cardiovascular testing prior to non-cardiac surgery). FIG. 4 illustrates the generation of recommendations for clinical decision support (action block 2004) in further detail.

Turning to FIG. 4, process 2004 begins with the standardized patient data obtained from action block 2003 (start block 4001). This information represents the aggregate of patient data from a variety of sources (e.g., patient Web portals, ambulatory EHRs, anesthesia information management systems, hospital records, and so on). To begin evaluating each of these discrete data points, process 2004 first determines whether each data point has an associated mapping ID (decision block 4002). The mapping ID is the successful translation of each item from action block 2003. Specifically, the mapping ID is the unique code for a patient data element using the single internal coding system of database 102B. In one example, for a database 102B that mapped all external health records to an ICD-9 code, decision block 4002 determines whether each data element is properly associated with an ICD-9 code. For those data elements that were not mapped in action block 2003, the data is flagged within database 102B or stored in a separate data structure within database 102B to indicate these data elements could not be found (action block 4004) and will not be evaluated for clinical recommendations. In one example, all C/M/A, demographics, surgery type, diagnosis, and procedure information that is not mapped to an ICD-9 ID is flagged and a report is generated (action block 4014) listing all patient data that was not found.

Conversely, using the mapping ID for each successfully mapped C/M/A and so on (decision block 4002), provider server 102 generates all possible recommendations that can be generated, which involve those specific C/M/As (i.e., mapping IDs) (action block 4003). Possible recommendations are the suggestions that can be generated in the clinical decision/recommendation report based on the patient health data (e.g., “Discontinue the use of blood thinners 24 hours before surgery” or “Do not eat 8 hours before surgery”). The set of possible recommendations that can be generated are specified for each facility (e.g., medical facility users 103) and often include, but are not limited to, selection and timing of preoperative testing, considerations for ordering preoperative consultations, management of medications in the perioperative period.

In order to evaluate whether a possible recommendation will be provided on the recommendation report, recommendation triggers are defined as the collection of patient data that may invoke a particular recommendation. For example, a possible recommendation to “discontinue ingestion 8 hours before surgery” is triggered if a patient's EHR indicates a specific combination of “heart surgery,” “low blood pressure,” and “Coumadin (blood thinner).” In this example, surgery type (i.e., heart surgery), patient condition (i.e., low blood pressure), and patient medications (i.e., Coumadin) are the recommendation triggers. The specific combination of recommendation triggers required can be specified by a physician and will be further discussed below with reference to decision block 4009.

If a particular set of C/M/As do not invoke any possible recommendations (decision block 4005), the C/M/As that did not invoke any possible recommendations are flagged within database 102B or stored in a separate data structure within database 102B to indicate these data elements do not trigger any preoperative recommendations (action block 4006). Specifically, C/M/As do not invoke any possible recommendations when they are not included in the recommendation triggers for any recommendation specified in provider server 102. These “non-triggering” C/M/As are displayed on the recommendation report such that both the physician and patient can review these specific C/M/As to verify whether any additional actions should be required.

For any possible recommendations that the patient's C/M/A invoked (decision block 4005), provider server 102 first determines whether the recommendation was previously evaluated (decision block 4007). For example, provider server 102 may have previously generated a recommendation report for a particular patient using an identical, or even a unique, set of C/M/As describing the patient's health record from the previous visit. The previous recommendation report may have included a recommendation to discontinue the use of blood thinners before surgery that was stored in provider server 102B. Provider server 102 will not evaluate a duplicate recommendation and continues to process any remaining possible recommendations (decision block 4012).

In the evaluation of a new possible recommendation (decision block 4007), provider server 102 then determines whether the possible recommendation is associated with any relative factors (action block 4008). Unlike recommendation triggers, factors are not specific to any C/M/A, but are pre-defined variables that may not only invoke a specific recommendation, similar to a recommendation trigger, but also limit the scope of an existing trigger. Factors include, but are not limited to, body mass index (“BMI”), gender, medical procedure performed, and medical procedure risk (i.e., low-, intermediate-, high-risk) (e.g., CPT). As an example, age and gender may be factors associated with a recommendation for discontinuing blood thinners such that female patients between the ages of 20-60 invoke an additional recommendation to perform a pregnancy test in addition to the blood thinner recommendation. Similarly, BMI may be another factor that generates a recommendation for obesity testing.

Once any associated factors are generated, provider server 102 evaluates both recommendation triggers and factors (decision block 4009). As previously mentioned, a specific combination of recommendation triggers may prompt the recommendation to display on the report. Both the specific combination of recommendation triggers and factors required as well as possible recommendations can be specified by a physician and based on medically recognized practice guidelines. In one embodiment, a boolean function is used to determine whether the necessary recommendation triggers exist for a possible recommendation in order to display the particular recommendation. Provider server 102 also evaluates any associated factors generated in action block 4008.

For example, a specific set of recommendations are evaluated to true if a patient's EHR indicates all of “Diabetes,” “heart failure,” patient is female, and over 60-years-old. A patient with the preceding EHR may receive recommendations for blood surgar testing on the day of surgery, possible cardiac evaluations, and an electrocardiogram (“EKG”). Alternatively, only a specific combination of recommendation triggers and factors may be required to evaluate a recommendation to true. For instance, the recommendation triggers and factors for a sleep disorder recommendation includes age over 50, BMI over 28, male gender, high blood pressure or blood pressure medication, snoring, neck circumference greater than 17 inches, fatigue during the day, and obstruction of breath during sleep. Accordingly, a recommendation to test for obstructive sleep apnea may be true if only three of the foregoing recommendation triggers and factors are met.

If provider server 102 evaluates a possible recommendation as true (i.e., all necessary recommendation triggers and factors are present in a patient's EHR) (decision block 4009), the recommendation is saved or flagged in database 102B for display on the patient's recommendation report (action block 4010). Storage of evaluated recommendations in database 102B provides the additional advantage of regenerating recommendation reports based on the current state of recommendations, triggers, and factors specified in provider server 102 at the time of the original report generation. Furthermore, the set of recommendation triggers and factors that were necessary for evaluating the recommendation as true is stored in relation with the specific recommendation (e.g., associative map) in database 102B. These recommendation triggers and factors will then be listed with the recommendation line item on the report such that the physician and patient can review which patient information “triggered” the recommendation. Process 2004 continues to evaluate any remaining recommendations (decision block 4012).

Similarly, if provider server 102 evaluates a recommendation as false (i.e., all necessary recommendation triggers and factors are not present) (decision block 4009), the recommendation is not saved or flagged in database 102B for display on the patient's recommendation report and the process 2004 continues to evaluate any remaining possible recommendations (decision block 4012). Once all possible recommendations have been evaluated (decision block 4012), provider server 102 then reviews the generated recommendations and determines any final display restrictions before generating the report (action block 4013).

Generated recommendations may have certain suppressions, which will prevent the display of the recommendation if user-specified rules are met. Unlike conventional methods for generating computer-based recommendations and clinical decision support, provider server 102 iterates through each generated recommendation to ensure whether that recommendation suppresses another generated recommendation (action block 4013). For example, a patient's health information may include the recommendation triggers and factors to generate two types of metabolic testing recommendations: a Comprehensive Metabolic Profile (“CMP”) and a Basic Metabolic Profile (“BMP”). However, a physician may pre-set suppressions to provider server 102 such that a CMP recommendation will override any BMP recommendations. Therefore, in this example, the generated report will only display the recommendation for a CMP and ignore the recommended BMP. After all suppressions are processed, the recommendation report is generated including all recommendations with respective triggers and factors, the recommendation triggers that were not mapped/found, and any non-triggering patient data (action block 4014). This report may be provided in a number of formats including both Web-based pages and text documents for alternative transmission (e.g., portable document file, Microsoft® Word).

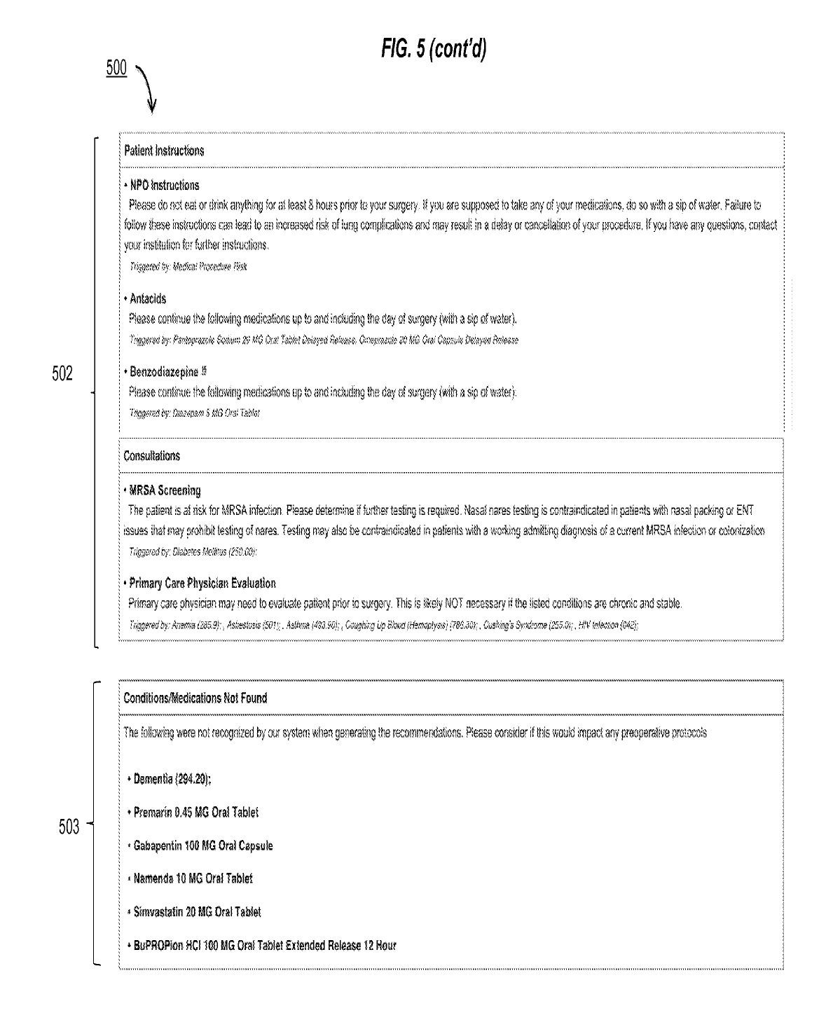

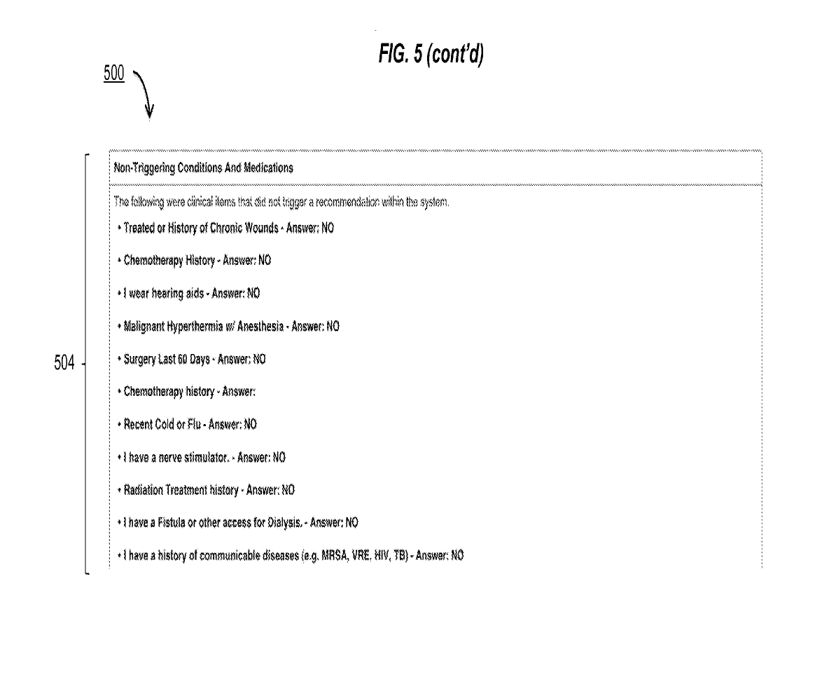

FIG. 5 illustrates a sample recommendaton report 500 in further detail. As shown, section 501 summarizes all patient information that was acquired from the patient in action block 2001. This section also contains information regarding health information and authorization requests. Section 502 provides recommendations (i.e., consultations and patient instructions) with respective triggers and factors that were not suppressed. Any recommendation triggers that were not mapped/found are listed in section 503 and any non-triggering patient data is included in section 504.

Returning to FIG. 2, after a recommendation report is generated, medical personnel have another chance to verify the generated information (action block 2005). The generated information can be viewed directly from provider server 102 and also over data network 101, such as from patient systems 103A, 103B, or 103N. In one embodiment, provider server 102 creates an interactive Web-based checklist using the recommendation report to allow the reviewer to ensure appropriate documentation has occurred and that critical information is reviewed. Using a checklist, surgeons and other medical personnel are engaged to follow the best practice guidelines.

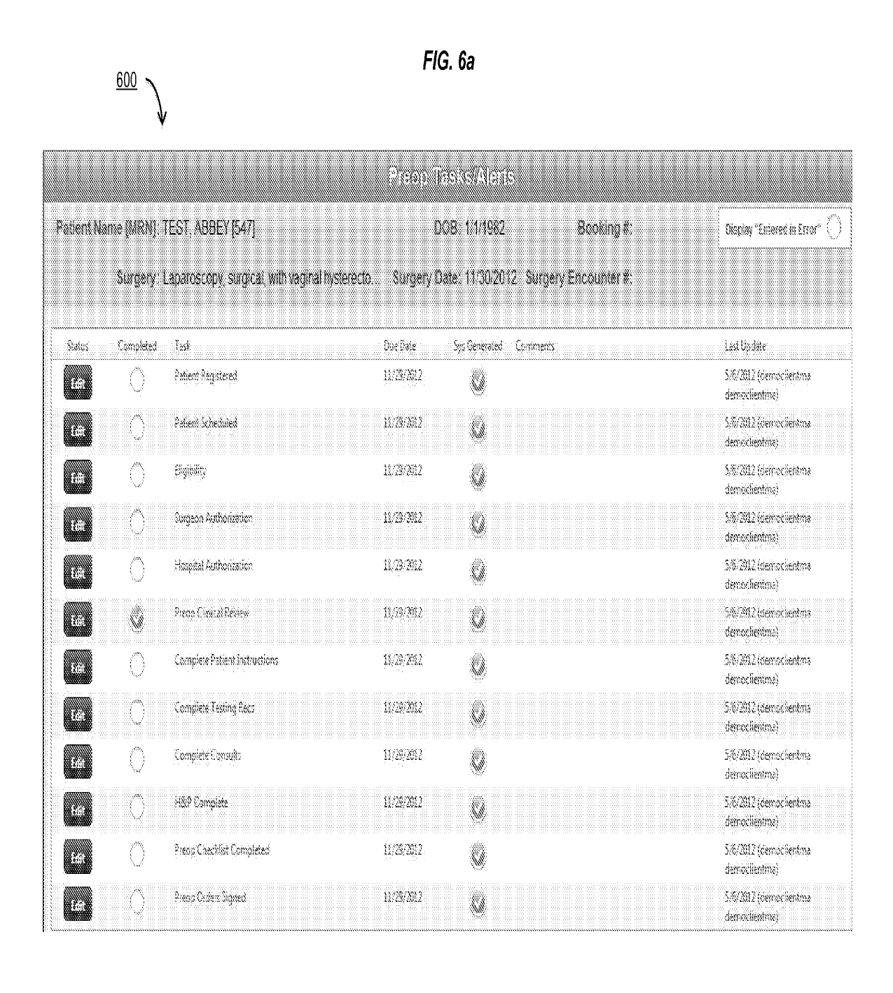

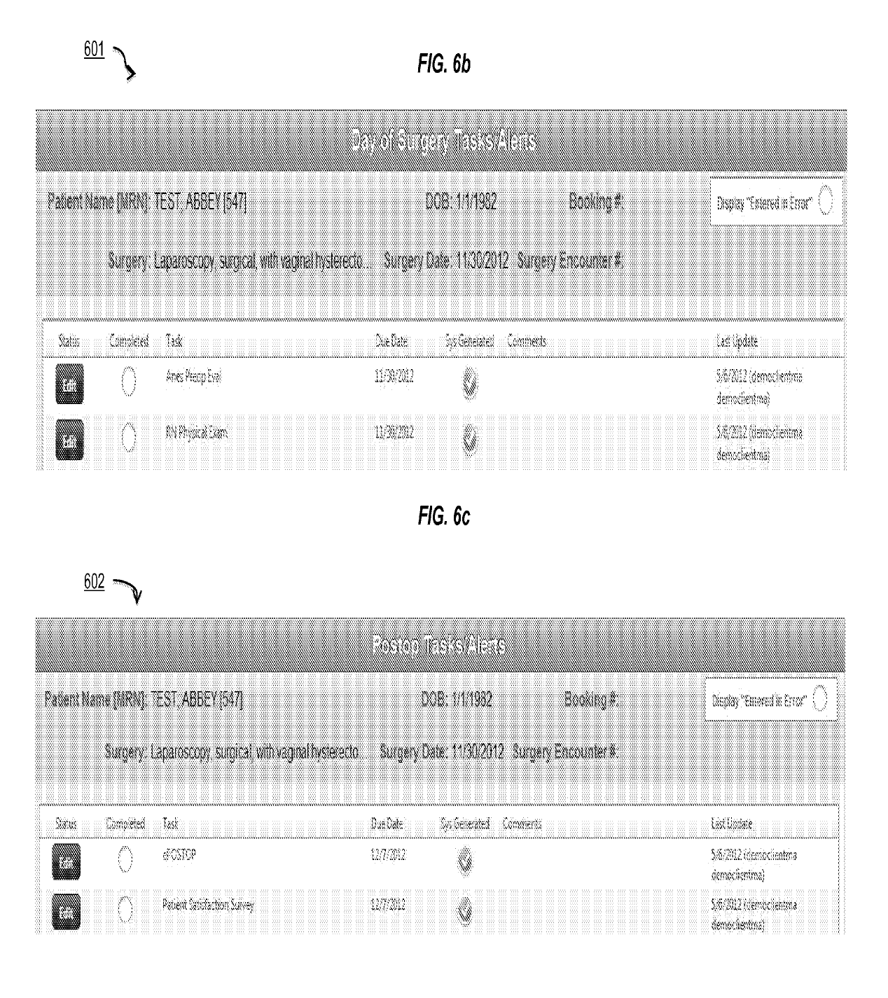

FIG. 6a provides a sample screenshot 600 of an exemplary interactive checklist for preoperative analysis based on a generated patient report. As illustrated, the interactive checklist system includes patient-specific tasks, instructions, testing and consulting considerations. This checklist (e.g., screenshot 600) can describe both general core tasks (i.e., programmatically updated for routine preoperative practices) and specific client tasks (i.e., user customized for procedure-specific requirements). In this example, screenshot 600 provides both general core tasks (e.g., completing testing recommendations, completing consultation recommendations, reviewing preoperative clinical review, and completing patient instructions) and specific client tasks (e.g., scheduling patients, surgeon authorization, hospital authorization, completing specific tests). Each generated recommendation includes its respective recommendation triggers/factors and a status that can be modified once actions are completed.

In an alternative embodiment, similar interactive checklists describing guidelines and recommendations for the day of surgery (e.g., as illustrated in screenshot 601 of FIG. 6b) and postoperative tasks (e.g., as illustrated in screenshot 602 of FIG. 6c) also can be generated.

In yet another embodiment, each interactive checklist generated may provide a Web-based link to instantly complete a specific task or recommendation (not shown) (e.g., ordering recommended/necessary tests). For example, a recommendation report generated in action block 2004 may include testing recommendations for both CMP and EKG. An interactive checklist based on this report can provide an instant Web-based link to electronically order each of these tests. A prescribing physician 103 viewing the report—using patient systems 103A, 103B, or 103N—can click on these links to approve and electronically sign the order required for a patient to obtain the respective test. The order can be communicated over data network 101 for processing to provider server 102. Having immediate access to these checklists at the point of care and the ability to instantly complete many of the recommended tasks, reviewers are encouraged to routinely follow approved practice procedures, provide appropriate recommendations, and evaluate procedure- and patient-specific tests. Accordingly, process 2000 promotes standardized medical processes and ensures quality of care for each patient.

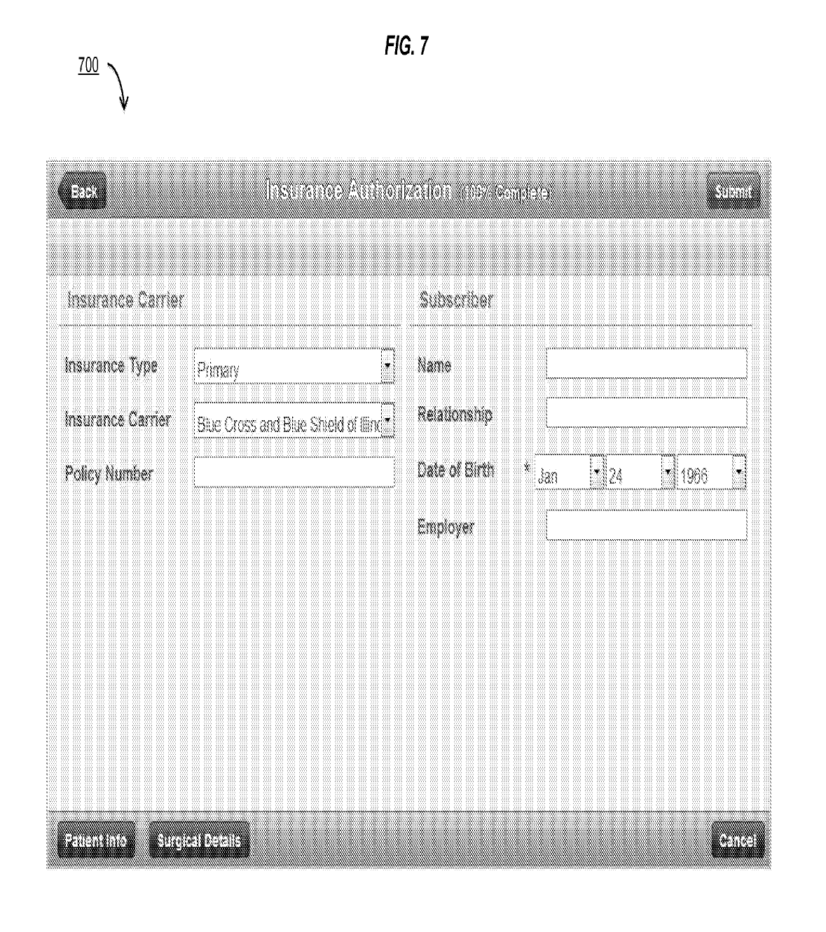

In addition to analyzing patient data, provider server 102 is also configured to submit coordinated insurance pre-authorization requests based on the patient's EHR stored in database 102B (action block 2006). As previously discussed, submission of insurance authorization requests is highly variable given the number of different health insurance providers, each with unique requirements. Provider server 102 is configured to receive health insurance authorization requirements from a number of health insurance providers, for example, using patient systems 103A, 103B, and 103N. Discrete patient data from database 102B is used to pre-fill insurance authorization request forms for electronic submission over data network 101. Thus, unlike conventional methods for maintaining health information, process 2000 takes advantage of previously acquired patient information to combine traditionally disparate processes (e.g., generating clinical decision support and submitting authorization requests) without altering the existing medical procedural workflow, in order to generate best practice guidelines that improve patient care. A sample screenshot 700 is shown in FIG. 7 that provides for a new insurance pre-authorization request form.

As illustrated, patient health information and procedural details are acquired from a patient's EHR stored in database 102B (i.e., in screenshot 700, this information is encapsulated and can be edited using the buttons shown). The screen allows for input to specify a destination insurance provider that is to receive the request form. Once this information is provided, the authorization is sent over data network 101 on behalf of the surgeon or medical facility, thereby reducing transaction delays and information requests. In a preferred embodiment, authorization requests are received and transmitted over data network 101 via health level seven (“HL7”) standards or related secure communication of Web services. Although process 2000 describes the generation of insurance pre-authorization requests, those of ordinary skill in the art would appreciate that similar authorization requests (e.g., surgical authorizations, nursing and anesthesia evaluations) can also be generated.

Process 2000 can similarly create an optional quality reporting record using EHRs stored in database 102B (action block 2007). In one embodiment, nurses and physicians enter postoperative outcome data to provider server 102. For example, these clinicians are prompted to record instances of postoperative nausea, vomiting, and stroke. Using this data in combination with the patient's existing EHR, information is sent over data network 101 to national registries for analysis to improve care and localized clinical decision support.

Finally, upon completion of generated reports and authorizations, provider server 102 securely distributes reports and patient information to any subscribing facility for secured local storage (e.g., updating subscribing patient systems 103A, 103B, and 103N) (end block 2008). Any modifications and updates made to patient information through provider server 102 are subsequently transferred to subscribing preoperative clinics, ambulatory surgical centers, hospitals and so on. This allows each facility to have real-time recommendations, patient information, and guidelines from a centralized, common source. In one embodiment, sensitive patient information is only provided based on pre-approved subscribing locations and the locations where electronic patient data was obtained in start block 2001. Patients and medical personnel have immediate access to the necessary information required for successful treatment and scheduling. Therefore, process 2000 provides fewer information exchanges, reduced human error, and decreased medical costs.

In the foregoing specification, the invention has been described with reference to specific embodiments thereof. It will, however, be evident that various modifications and changes may be made thereto without departing from the broader spirit and scope of the invention. For example, the reader is to understand that the specific ordering and combination of process actions described herein is merely illustrative, and the invention may appropriately be performed using different or additional process actions, or a different combination or ordering of process actions. For example, this invention is particularly suited for pre-surgical patient information systems, such as fully-integrated HIM systems; however, the invention can be used for any electronic health management system. Additionally and obviously, features may be added or subtracted as desired. Accordingly, the invention is not to be restricted except in light of the attached claims and their equivalents.

What is claimed is:

1. A health information management (“HIM”) system comprising:
a provider server accessible over a data network from one or more client devices;
a database communicatively coupled to the provider server, wherein the database is configured to maintain one or more electronic health records (“EHR”) describing electronically transferrable patient health information; and
wherein the provider server includes a computer program product operatively coupled to the database, the computer program product having a computer-usable medium having a sequence of instructions which, when executed by a processor, causes said processor to execute a process that coordinates the delivery of transferrable patient health information between the provider server and the one or more client devices and provides preoperative testing recommendations based on an algorithmic analysis of said patient health information, said process comprising:
receiving patient health information over said data network for storage in said database, wherein said patient health information is identifiable via medical classifications;
mapping patient health information to a single standardized coding format;
submitting authorization requests using said standardized patient health information over the data network; and
generating patient-specific clinical decision support in the form of evidence-based testing guidelines and preoperative recommendations, wherein the recommendations are based on a combination of medical triggers and factors acquired from the database and any corresponding standardized patient health information.

2. The system of claim 1, wherein the step of receiving patient health information further comprises extracting discrete patient data from one or more client devices, and storing said discrete patient data in said database as said patient health information.

3. The system of claim 1, wherein the provider server further hosts one or more Web-pages accessible over data network; and the step of receiving patient health information further comprises receiving discrete patient data through the one or more Web-pages, and storing said discrete patient data as said patient health information.

4. The system of claim 1, wherein the process further comprises generating an interactive checklist having one or more tasks based on said patient-specific clinical decision support.

5. The system of claim 1, wherein mapping patient health information is based on the Unified Medical Language System (“UMLS”).

6. The system of claim 1, wherein said single standardized coding format uses the International Statistical Classification of Diseases and Related Health Problems, Ninth Revision (“ICD-9”).

7. The system of claim 1, wherein said authorization requests are selected from the group consisting of: (1) health insurance authroziation request; (2) surgical authorization request; and (3) scheduling requests.

8. The system of claim 1, further comprising a user interface console to modify the computer program product.

9. The system of claim 8, wherein the user interface console modifies at least one selected from the group consisting of: (1) recommendation triggers and factors; (2) authorization request requirements; (3) medical classification/coding used; (4) recommendation suppressions; and (5) subscribing client devices.

10. The system of claim 1, wherein the process further comprises generating a quality reporting record from said patient health information.

11. A method of coordinating the delivery of transferrable patient health information between a provider server and one or more client devices over a data network, the method comprising:
receiving patient health information over said data network for storage in a database, wherein said patient health information is identifiable via medical classifications;
mapping patient health information to a single standardized coding format;
submitting authorization requests using said patient health information over the data network; and
generating patient-specific clinical decision support in the form of evidence-based testing guidelines and preoperative recommendations, wherein the recommendations are based on a combination of medical triggers and factors acquired from the database and any corresponding patient health information.

12. The method of claim 11, further comprising distributing patient health information from said provider server to the one or more client devices over said data network.

13. The method of claim 11, wherein said recommendation triggers and factors for generating patient-specific clinical decision support are based on the American College of Cardiology/American Heart Association (“ACC/AHA”) Guidelines on Perioperative Cardiovascular Evaluation and Care for Non-cardiac Surgery.

14. The method of claim 11, wherein generating patient-specific clinical decision support in the form of evidence-based testing guidelines and preoperative recommendations further comprises suppressing any of said generated recommendations and guidelines for any conflicting generated recommendation or guideline.

15. The method of claim 11, wherein the step of receiving patient health information further comprises extracting discrete patient data from one or more client devices, and storing said discrete patient data in said database as said patient health information.

16. The method of claim 11, further comprising generating an interactive checklist having one or more tasks based on said patient-specific clinical decision support

17. The method of claim 11, further comprising storing said standardized patient health information, testing guidelines, and recommendations in a database.

18. The method of claim 11, wherein mapping patient health information is based on the Unified Medical Language System (“UMLS”).

19. The method of claim 11, wherein said single standardized coding format uses the International Statistical Classification of Diseases and Related Health Problems, Ninth Revision (“ICD-9”).

20. The method of claim 11, further comprising genearing a quality reporting record from said patient health information.
